(19) United States
(12) Patent Application Publication
(10) Pub. No.: US 2022/0325856 A1
(43) Pub. Date: Oct. 13, 2022

(54) LUMINAIRE HAVING A REGION FOR EMITTING LIGHT OVER A SURFACE

(71) Applicant: ZUMTOBEL LIGHTING GMBH, Dornbirn (AT)

(72) Inventor: Julian Lonsdale, Hohenweiler (AT)

(73) Assignee: ZUMTOBEL LIGHTING GMBH, Dornbirn (AT)

(21) Appl. No.: 17/639,974

(22) PCT Filed: Jul. 20, 2020
(86) PCT No.: PCT/EP2020/070411

§ 371 Date: Mar. 3, 2022

(30) Foreign Application Priority Data
Sep. 24, 2019 (DE) 20 2019 105 265.1

(51) Int. Cl. F21S 4/28; F21V 3/04; F21V 5/00; F21V 17/16

(52) U.S. Cl. CPC F21S 4/28; F21V 3/049; F21V 5/005; F21V 17/162; F21Y 2115/10

(57) ABSTRACT

The invention relates to a luminaire (100), comprising lighting means (18) and a cover (20), which has at least one planar region (25) for emitting light, the planar region for emitting light (25) consisting of a transparent material and being provided, on at least one side, with a structure (26), and a plate-shaped light-influencing element (30) being arranged between the lighting means (18) and the planar region (25) for emitting light, a pattern (35) being printed on the light-influencing element.

### CROSS-REFERENCE TO RELATED APPLICATION

The present application is the U.S. national stage application of international application PCT/EP2020/070411 filed Jul. 20, 200, which international application was published on Apr. 1, 2021 as International Publication WO 2021/058167 A1. The international application claims priority to German Patent Application 20 2019 105 265.1 filed Sep. 24, 2019.

### FIELD OF THE INVENTION

The present invention relates to a luminaire according to the preamble of claim 1, which comprises lighting means and a cover which forms at least one planar region for emitting light.

### BACKGROUND OF THE INVENTION

Modern luminaires are often configured such that they do not only emit light in one way, but rather such that there is also a further or additional emission of light. While the primary emission of light serves to fulfill the task of the luminaire with regard to the area in which it is being used, the additional emission of light is used to create so-called accent lighting, for example, or to brighten up an additional area in order to improve the resulting overall appearance of the luminaire itself and also of the illuminated area. The primary emission of light then serves, for example, to selectively illuminate a specific area below the luminaire, e.g. for work purposes, or selectively brighten areas below the luminaire.

A luminaire that emits light in different ways in the sense of the above discussion is sold by the Applicant under the name “ECOOS”. This is a luminaire that extends in longitudinal direction in which the lighting means are enclosed by an approximately U-shaped cover. The underside of the cover is used for a directed emission of light to illuminate workplaces or the like, while a smaller portion of the light is additionally emitted via the side walls of the cover to improve the appearance of the luminaire overall. It is provided here that perforated aluminum reflectors are disposed inside the luminaire on both sides of the lighting means in front of the side walls of the cover, the hole pattern of which allows a portion of the light to pass through, which is then emitted via the side walls of the cover. The aluminum reflectors reduce the portion of the light emitted via the side walls in such a way that there is no risk of glare effects. Furthermore, due to the fact that the reflectors have a certain distance from the side walls of the cover, a so-called depth effect is created, so that the luminaire appears overall as a brilliant object. Nonetheless, with the aid of this luminaire, work spaces or communication areas can be illuminated efficiently, because a large part of the light produced by the lighting means is emitted in the desired manner directed toward the underside.

As already stated, the aforementioned luminaire is characterized by its particularly attractive emission of light and the resulting appearance. However, it has been found that the use of the perforated aluminum reflectors responsible for the appearance is associated with certain disadvantages.

For one thing, they are relatively expensive to produce and, due to their reflective properties, allow only limited control in terms of the portion of light emitted via the side surfaces of the cover. Also, there are certain limitations when producing the hole pattern of the reflectors. The holes have to be punched into the reflector in a respective work step, whereby this is practically possible only within certain dimensions. In particular very small holes or openings for the emission of light, and thus very fine patterns, can only be created with considerable effort or not at all.

### SUMMARY OF THE INVENTION

The underlying object of the present invention is therefore to provide a novel way to achieve an emission of light for a luminaire comparable to the emission of light described above, but reduce the required effort.

This object is achieved with a luminaire having the features of claim 1. Advantageous further developments of the invention are the subject matter of the dependent claims.

As already stated, with the aid of the luminaire according to the invention, the intent is to at least in part again achieve an emission of light that creates the aforementioned depth effect for an observer. This is now achieved according to the invention in that the region of a light emitting element provided for the respective emission of light consists of a transparent material and is provided on one side with a structure. A plate-shaped light influencing element, which consists of a light-permeable material but is printed with a pattern, is furthermore disposed between the lighting means and the planar region for emitting light.

herefore, according to the present invention, a luminaire with lighting means and a cover is proposed, which forms at least one planar region for emitting light, wherein the planar region for emitting light consists of a transparent material and is provided on at least one side with a structure and wherein a plate-shaped light influencing element, which is made of a light-permeable material and is provided with a pattern, in particular printed with a pattern, is disposed between the lighting means and the planar region for emitting light.

From the perspective of an observer looking at the luminaire, there is then a superposition of the structure of the cover on the one hand and, on the other hand, of the pattern of the additional plate-shaped light influencing element. This produces a so-called moiré effect, which means that, when the observer's viewing angle changes, the resulting pattern as a whole also changes. This leads to the discussed and desired depth effect when looking at the luminaire, so that the light here is emitted in a particularly attractive manner. At the same time, however, this effect is significantly easier to implement compared to the solution known to date in the prior art, because printing of the plate-shaped light influencing element can be carried out more easily, more cost-effectively and, nonetheless, with greater precision. Ultimately, therefore, the way in which the light is emitted by the luminaire can be influenced even more effectively.

The structure of the cover is preferably configured on the inner side of the planar region for emitting light. The outer side of this region of the cover, on the other hand, is ideally completely smooth, which not only prevents the accumulation of dust and dirt but also further improves the appearance of the luminaire.

It is preferably provided that the luminaire extends along a longitudinal axis and the structure of the cover is configured in a translationally invariant manner parallel to the longitudinal axis. The structure can in particular be Fresnel-like or formed by a prism structure which extends in longitudinal direction. Said prism structure can comprise in particular sawtooth-shaped elevations which are triangular in cross-section.

The plate-shaped light influencing element, which is printed with the pattern, is preferably formed by a plastic film. Said film ideally has a certain strength, and thus inherent stability, so that it can easily be mounted clamped into the cover. The pattern with which the film is printed is preferably configured such that it is periodic in the longitudinal direction of the luminaire. In a direction perpendicular to the longitudinal direction, on the other hand, it can be provided that the pattern changes.

The cover of the luminaire according to the invention is preferably U-shaped with two side walls and a bottom wall which connects the side wall, whereby the two side walls form planar regions for emitting light and are configured in the sense of the present invention as discussed above. The bottom surface of the cover, on the other hand, is preferably likewise configured to be light-permeable, but is provided for the primary emission of light of the luminaire. Different measures for influencing the emitted light, which ensure that the emission of light fulfils the lighting task of the luminaire, can be provided here.

Ultimately, therefore, the solution according to the invention makes it possible to implement a luminaire which, in terms of its light emission properties, is at least equivalent to the above-described previously known luminaire, whereby, however, the positive appearance of the luminaire can be realized with significantly less effort and in particular also more cost-effectively.

### BRIEF DESCRIPTION OF THE DRAWINGS

The invention will be explained in more detail in the following with reference to the accompanying drawing. The figures show:

FIG. 1 a view of the end region of a luminaire according to the invention;

FIG. 2 a sectional view of the luminaire perpendicular to the longitudinal axis, wherein the components responsible for the emission of light can be seen;

FIG. 2a an enlarged view of a portion of a side wall of the luminaire cover;

FIG. 3 a side view of the planar region of the cover provided for the emission of light according to the invention;

FIG. 4 different variants of patterns for printing the additional light influencing element, and

FIG. 5 the appearance of the luminaire resulting from the superposition of the structure of the cover with the pattern.

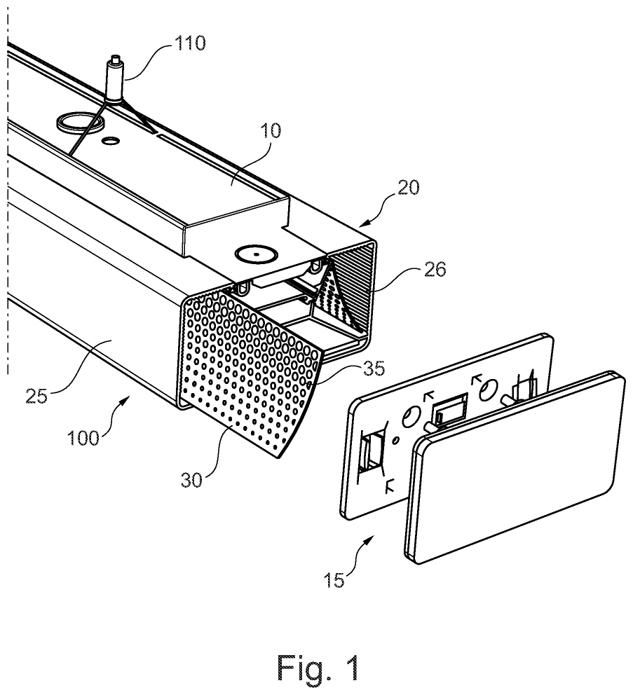

### DETAILED DESCRIPTION

The measures according to the invention for producing the special lighting effect will be described in the following with reference to a design example of a luminaire, the structure of which corresponds in general to the above-described luminaire known from the prior art. It should be noted, however, that the emission of light according to the invention could also be used in luminaires having different designs.

The luminaire generally provided with the reference sign 100 in the figures is elongate and, in the illustrated design example, is configured as a pendant light. In a similar way, however, mounting the luminaire 100 on the ceiling would be conceivable too.

The central holding element of the luminaire 100 is a carrier 10, which extends in longitudinal direction and holds all of the other components of the luminaire 100, and to which the respective suspension elements 110 are also fastened. In particular, however, the carrier 100 holds the lighting means needed to produce the light, as well as any necessary operating means that convert a supply voltage provided to the luminaire 100 into a voltage suitable for operating the lighting means. This applies in particular to the preferred case, in which LED circuit boards that extend in the longitudinal direction and comprise a plurality of successively disposed LEDs are used as lighting means.

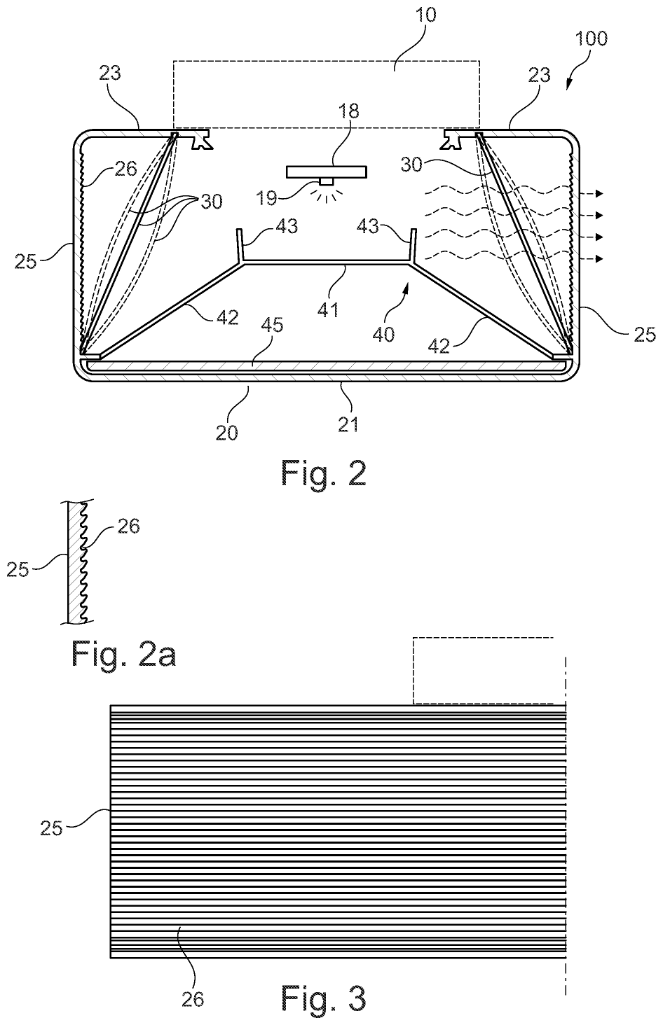

A cover 20, which in cross-section has the shape that can in particular be seen in FIG. 2, is furthermore fastened to the carrier 10. The cross-sectional shape is therefore roughly U-shaped and comprises a bottom surface 21 and two side walls 25. On its upper side facing the carrier 10, however, the cover 20 is additionally configured with inwardly directed wall regions 23 that extend toward the carrier 10. Overall, therefore, the cover 20 encloses an elongated rectangular receiving space in which the components of the luminaire 100 responsible for producing and emitting light are disposed.

On the end faces, the luminaire 100 is respectively closed off by corresponding end elements 15, which are fitted onto the open end regions of the cover 20 and connected to it here. The space inside the cover 20 is thus completely enclosed, so that the luminaire 100 can, if necessary, also meet the requirements of respective so-called protection classes, i.e. is appropriately protected against the ingress of dust, dirt, and/or moisture.

The cover 20 as a whole consists of a light-permeable, preferably clear material. It is accordingly provided that light is emitted via all of the surfaces, so that it can be said that, relative to the longitudinal axis of the luminaire 100, light is emitted over 360°.

The primary emission of light should take place via the bottom surface 21, so that there is a direct emission of light toward the underside, which is used to illuminate work surfaces or workspaces, for example, or objects below the luminaire 100. The two upper wall regions 23 of the cover 20, on the other hand, serve to emit a small portion of the light upward, for example in the direction of a ceiling of a room in which the luminaire 100 is mounted. The ceiling region above the luminaire 100 can thus be brightened a little bit. This portion of the light emitted indirectly into the room is also directed onto the work surface via reflections on boundary surfaces of the room and, as a supplement to the other light portions, is significantly responsible for a pleasant ambience in the room.

If necessary, a structure or the like can be provided on the surface of the wall sections 23 of the cover 20 facing the interior to bring about a better distribution of the upward emitted light. In order to influence the light in the desired manner, the measures described in more detail in the following are also provided for the emission of light toward the underside.

To start, an optical element 40 is disposed inside the space enclosed by the cover 20, which is made of a light-diffusing material and serves to influence the light of the lighting means 18, 19 shown schematically in FIG. 2 before it is emitted in particular via the bottom side 21 of the cover 20. The light-diffusing element 40 has an approximately H-shaped cross-section with a horizontal surface 41 disposed below the lighting means 18, 19, from which two arms 42 extend obliquely downward substantially toward the lower corners of the cover 20. The element 40 is preferably an integral part of the extruded cover 20 and is therefore connected to said cover at the lower ends, as shown in FIG. 2. However, whereas the various side walls 21, 23, 25 of the cover are made of a clear material, the light influencing element 40 is preferably configured entirely of a light-diffusing material. Upwardly extending webs 43 are furthermore provided on each of the side regions of horizontal surface 41.

The light influencing element 40 then serves to resolve the individual LEDs 19 as individual points of light. This is important in particular for the emission of light via the bottom surface 21 of the cover 20, because the intent here is to achieve as uniform an illumination of the area to be illuminated as possible and also for the LEDs to no longer be perceived as individual lighting means.

Another plate-shaped element 45 comprising micropyramidal optics on a flat side is preferably further disposed in the region of the clear bottom surface 21. Such micropyramidal optics are already known per se and are used in lighting technology to influence the light emitted in a planar manner in such a way that it leaves the luminaire over a predefined angular range, which is in particular selected such that no annoying reflections or other glare effects occur. At the same time, these micropyramidal optics also further contribute to ensuring that the individual LEDs 19 cannot be perceived as individual light sources.

In the presented case, the micropyramidal optics is, as already stated, a component of a separate plate-shaped element 45 which is inserted or pushed into the bottom region of the cover 20, whereby a not-depicted diffusely scattering film which rests on said element 45 can optionally be provided. However, if necessary, the micropyramidal optics could also already be integrated into the bottom surface 21 of the cover 20. Thus, in the illustrated luminaire 100, the light emitted directly toward the underside is successively influenced by a plurality of components: H-shaped diffuser 40 (diffusely scattering)—perhaps an MPO film (diffusely scattering)—plate 45 with a micropyramidal structure—clear bottom surface 21 of the cover 20.

The present invention relates in particular to the emission of light via the side walls 25 of the cover 20, which is intended to lead to an optimized appearance of the luminaire 100. The focus here is less on the aspect of illuminating a specific area outside the luminaire 100; rather the intent is that a relatively small portion of the light of the lighting means 18 be emitted laterally, such that the luminaire 100 looks particularly attractive to an observer.

To this end, it is provided that the side walls 25 of the cover 20 preferably consist of a clear material, but comprise a structure that can be seen in FIG. 2 and is shown enlarged in section in FIG. 2a. This Fresnel-like structure 26 consists of elevations that face the interior of the luminaire 100 and are configured in a prism-like manner. In the shown design example, they in particular have a triangular, particularly preferably sawtooth-like, cross-sectional shape in order to accordingly influence light beams passing through the respective side walls 25.

As the side view according to FIG. 3 shows, it is preferably provided that the structure 26 be translationally invariant when viewed in the longitudinal direction, i.e. does not change in the longitudinal direction of the luminaire 100. In principle, however, it would also be conceivable to use structures having a different design, in particular prism or lens structures configured in a matrix-like manner.

Structures, as just described, to positively influence the emission of light of a luminaire are already known per se. According to the present invention, however, it is now provided that the light of the lighting means is additionally influenced by two light influencing elements 30 disposed laterally in the interior of the luminaire 100 before it can leave the cover 20 via the side walls 25. These are again elements that consist of a light-permeable material, but are additionally provided, in particular printed, with a pattern 35, which is discussed in further detail in the following.

The light influencing elements 30 are preferably provided in the form of films, which are then clamped into the cover 20 of the luminaire 100 as shown in FIG. 2. For this purpose, the films have a certain thickness, for example about 0.5 mm, so that the resulting light influencing element 30 has a corresponding inherent stability in order to enable clamping in the shown manner. Depending on the dimensions, in particular the height of the light influencing element 30, it can be provided that said element extends obliquely upward in a straight line from the lower corner region of the cover 20 as is shown in FIG. 2 with the solid lines. However, it can also be provided that the height of the light influencing element 30 be selected to be somewhat larger, so that the film is clamped into the cover 20 pretensioned and convexly or concavely domed.

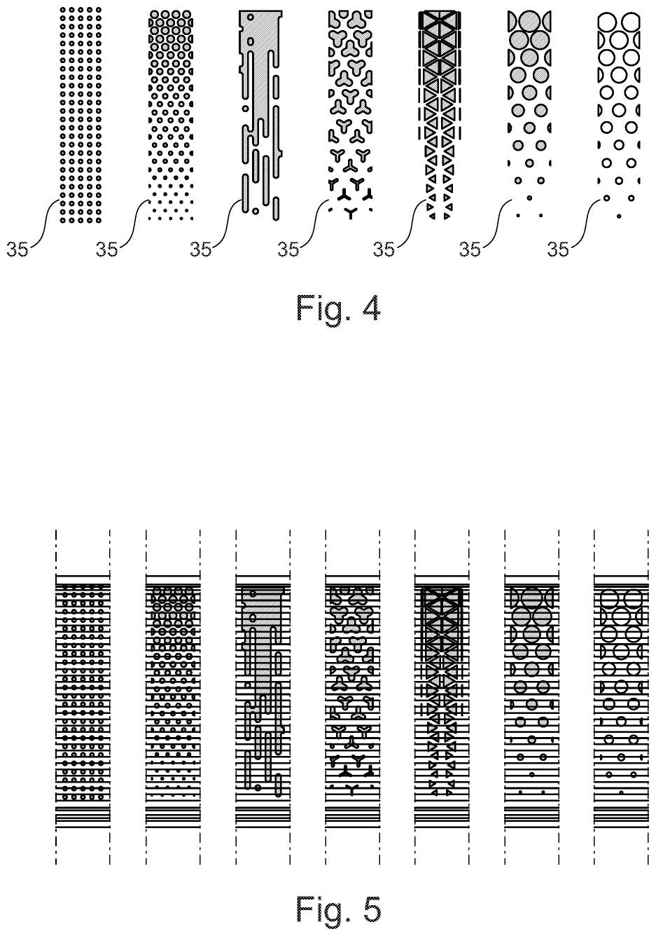

The decisive factor is that the additional light influencing element 30 has a certain distance from the side wall 25 of the cover 20 and, as already stated, is provided with a pattern 35. FIG. 4 shows examples of different possible patterns 35, whereby these patterns 35 again either do not change in longitudinal direction, or are at least configured such that they are periodic or repetitive. In a direction perpendicular thereto, i.e. from top to bottom in the illustration according to FIG. 4, on the other hand, a change of the pattern 35 can indeed be provided, which in particular takes into account the fact that the lower regions of the light influencing element 30 are further away from the light sources 18 and a somewhat smaller portion of light will pass through here. Accordingly, it can in particular be provided that the size or density of the structures of the pattern 35 decrease toward the underside.

Light that is emitted via the side walls of the cover 20 is therefore influenced, on the one hand, by the printed pattern 35 of the light influencing element 30 and, on the other hand, by the structure 26 of the side walls 25 of the cover 20. This then results in a so-called moiré effect; i.e. an optical effect created by the superposition of regular, smaller structures. Such a superposition typically results in the observer having the impression of a larger, coarse grid, the appearance of which is similar to the patterns of interference. Such effects occur in digital photography, for example. However, while they are rather undesirable there, in the present case they result in a depth effect for an observer when observing the side walls 25 of the luminaire 100, so that a specific appearance is achieved. FIG. 5 indicates the extent to which the original pattern 35 according to the illustration in FIG. 4 is influenced by the superposition with the structure 26 of the side wall 25. Of course, even slight changes in the viewing angle then cause the superposition to result in a different appearance, which ultimately produces the desired depth effect.

The interaction between the structure 26 and the printed pattern 35 is particularly efficient when the size ratios of the two components are comparable. This means that the sizes of the smallest components of the printed pattern 35 are approximately similar to those of the Fresnel-like structures of the side walls 25. In a preferred design example, it is provided that these sawtooth-like structures have dimensions in the range of approximately 1.5 mm, in which case the corresponding individual structures in the patterns 35 shown in FIG. 4 should then also be selected to be in approximately the same size range.

One advantage of the solution according to the invention is that the printing of the optical elements 30 with the different patterns 35 can be carried out in a very simple, but nonetheless precise, manner. Ultimately, this opens up the possibility of also being able to provide different patterns in a simple way. It is preferably provided here that the dark regions of the pattern be configured to be not completely light-blocking, but rather that there is a contrast between the light and the dark areas of the printing, which is in the range of about 30-50%. It has been found that, on the one hand, this still allows a sufficiently high quantity of light to be emitted via the side walls 25 of the cover 20 while, on the other hand, nonetheless making it possible to realize the discussed depth effect in a sufficiently perceptible manner.

Ultimately, therefore, the invention creates a luminaire which, due to extremely attractive lighting effects, results in a positive appearance. One advantage of the solution is in particular that the effort required to achieve the special lighting effects is relatively low.

1. A luminaire (100) comprising lighting means (18) and a cover (20) having at least one planar region (25) for emitting light,
wherein the planar region for emitting light (25) consists of a transparent material and is provided on at least one side with a structure (26),
and wherein a plate-shaped light influencing element (30) which is printed with a pattern (35) is disposed between the lighting means (18) and the planar region (25) for emitting light.

2. The luminaire according to claim 1, characterized in that the structure (26) is configured on the inner side of the planar region for emitting light (25).

3. The luminaire according to claim 1, wherein the luminaire (100) extends along a longitudinal axis and the structure (26) is configured in a translationally invariant manner in a direction parallel to the longitudinal axis.

4. The luminaire according to claim 3, wherein the structure (26) is Fresnel-like or is formed by a prism structure which extends in longitudinal direction.

5. The luminaire according to claim 4, wherein the prism structure comprises in particular sawtooth-shaped elevations (27) which are triangular in cross-section.

6. The luminaire according to claim 1, wherein the plate-shaped light influencing element (30) is formed by a plastic film.

7. The luminaire according to claim 6, wherein the film is mounted clamped into the cover (20).

8. The luminaire according to claim 1, wherein the pattern (35) is configured such that it is periodic in longitudinal direction.

9. The luminaire according to claim 8, wherein the pattern (35) is configured such that it changes in a direction perpendicular to the longitudinal direction.

10. The luminaire according to claim 1, wherein the cover (20) is U-shaped with two side walls and a bottom surface (21) which connects the side wall, wherein the two side walls form planar regions for emitting light (25).

11. The luminaire according to claim 10, wherein the bottom surface (21) of the cover (20) is also configured to be light-permeable.

12. The luminaire according to claim 11, wherein a light-diffusing element (40) is disposed in front of the bottom surface (21).

13. The luminaire according to claim 12, wherein the light-diffusing element comprises a wall (41) disposed parallel to the bottom surface (21) of the cover and two arms (42) that extend from said wall in a trapezoidal manner.

14. The luminaire according to claim 12, wherein the light-diffusing element (40) is integrally connected to the cover (20).

15. The luminaire according to claim 12, wherein a further optical element (45) comprising a micropyramidal structure is disposed between the light-diffusing element (40) and the bottom surface (21) of the cover (20).
